(19) United States
(12) Patent Application Publication
(10) Pub. No.: US 2009/0277185 A1
(43) Pub. Date: Nov. 12, 2009

(54) PROPORTIONAL FUEL PRESSURE AMPLITUDE CONTROL IN GAS TURBINE ENGINES

(76) Inventors: Jerry L. Goeke, West Des Moines, IA (US); Brandon P. Williams, Urbandale, IA (US)

Correspondence Address: EDWARDS ANGELL PALMER & DODGE LLP, P.O. BOX 55874, BOSTON, MA, 02205, US

(21) Appl. No.: 12/116,928

(22) Filed: May 7, 2008

(51) Int. Cl. F02C 9/26

(52) U.S. Cl. 60/776; 60/741; 60/739

(57) ABSTRACT

Valve systems for controlling a flow of fuel in a gas turbine engine and related methods are provided. In one embodiment, the valve system includes a supply conduit, a proportional valve portion, and a pulsating valve portion. The supply conduit is adapted and configured for receiving and carrying a flow of fuel. The proportional valve portion is in fluid connection with the supply conduit adapted and configured to gradually adjust a pressure drop thereacross and thus a flow rate of fuel flowing therethrough. The pulsating valve portion is in fluid connection with the supply conduit, in parallel with the proportional valve portion, and is adapted and configured to rapidly adjust a pressure drop thereacross and thus a flow rate of fuel flowing therethrough.

### BACKGROUND

1. Field of the Invention

The subject invention is directed to gas turbine engines, and more particularly, to a valve system and related methods for adjusting fuel pressure delivered to fuel injectors associated with the combustor of a gas turbine engine for actively controlling the combustion process to maintain combustion stability and otherwise optimize engine performance.

2. Background of the Related Art

Combustion instability is a significant problem in the design of low-emission, high performing combustion chambers for gas turbines. Combustion instability is generally understood as high amplitude pressure oscillations that occur as a result of the turbulent nature of the combustion process and the large volumetric energy release within the combustion chamber. Combustion instability diminishes engine system performance, and the vibrations resulting from pressure oscillations can damage hardware components, including the combustion chamber itself. Moreover, when the combustion heat release becomes in phase with, and reinforces acoustic pressure waves, a thermo-acoustic instability results.

In the past, passive control methods were employed to correct combustion instability, including, for example, modifying the fuel injection distribution pattern, or changing the shape or capacity of the combustion chamber. Passive controls are often costly and limit combustor performance. More recently, active control methods have been used to correct combustion instability by modifying the pressure within the system. One way this can be done is by sensing the amplitudes and frequencies of acoustic pressure waves, and then modulating fuel injection at frequencies out of phase with the instabilities.

Currently, fuel injector flow rates are controlled by changing the fuel pressure feeding a common fuel manifold, with no individual control to each of the fuel injectors. For example, U.S. Pat. No. 6,672,071, which is hereby incorporated by reference in its entirety, discloses a combustion control system that includes a fuel pulsator communicating with a plurality of fuel injectors through a manifold. Fuel is pulsed to the injectors through the manifold at a frequency that promotes stable combustion.

Applicants recognize, however, that combustion stability can be achieved more effectively with active controls, if fuel flow is modulated or pulsed at each fuel injector individually.

Moreover, U.S. Patent Publication No. 2007/0151252 to Cornwell et al., which is incorporated herein by reference, in its entirety, discloses a plurality of valve arrangements capable of operating at high frequency (of up to and beyond 1000 Hz) to provide fuel pulsations at the desired frequency to promote combustion stability, for example. The valves described therein provide rotating elements that modulate fuel, as commanded by a control system. Although the devices described can be embodied with multiple valve elements to result in a wide variety of flow conditions, applicants recognize that such valves can also be embodied with a single rotating valve element. Applicants further recognize that with only a single valve element having fully open, fully closed and optionally a neutral position, as in the Cornwell publication, very few flow conditions are possible. Accordingly, only one pressure amplitude of fuel modulation is available for any given frequency of combustion instability, and a system may be under-controlling instability when the valve is not operating, or over-controlling stability when the valve is operating.

Applicants further recognize, therefore, that it would be advantageous to provide a valve that is capable of rapidly acting at high frequencies to temper combustion instability, but which is adjustable so as to provide a range of pressure amplitudes of fuel pressure to modulate varying degrees of instability. The present invention provides a solution to these needs.

### SUMMARY OF THE INVENTION

The present invention is directed to control of fuel flow in gas turbine engines. Particularly, the present invention is directed to systems and methods for proportional control of pressure waves created using a pulsating fuel valve when controlling combustion stability, for example.

In accordance with one aspect of the invention, a valve system for controlling a flow of fuel in a gas turbine engine is provided with valve portions provided in parallel. The valve system includes a supply conduit, a proportional valve portion, and a pulsating valve portion. The supply conduit is adapted and configured for receiving and carrying a flow of fuel. The proportional valve portion is in fluid connection with the supply conduit adapted and configured to gradually open or close, thereby resulting in a change in pressure drop across the valve. The pulsating valve portion is in fluid connection with the supply conduit, in parallel with the proportional valve portion, and is adapted and configured to rapidly adjust a pressure drop thereacross. The valve system can be used for the purpose of maintaining combustion stability, for example.

A delivery conduit can further be provided in fluid communication with an outlet of the proportional and pulsating valve portions, and be adapted and configured for conducting a flow of fuel therefrom, to at least one fuel circuit of a fuel injector.

Alternatively, fuel flow can be to a manifold for distributing a flow of fuel to a plurality of fuel injectors.

Alternatively still, the proportional valve portion can be in fluid communication with a manifold to adjust a pressure of fuel delivered to a plurality of fuel injectors, and a plurality of pulsating valve portions can be provided and configured to each adjust fuel pressure provided to respective fuel injectors. If so embodied, a flow of fuel from the proportional valve portion can be fed through the manifold to a first fuel circuit of a fuel injector and a flow of fuel from one of the pulsating valve portions can be fed to a second fuel circuit of the fuel injector. Alternatively, a flow of fuel from the proportional valve portion can be fed through the manifold to a first fuel circuit of a fuel injector and a flow of fuel from one of the pulsating valve portions can also be fed to the first fuel circuit of the fuel injector.

In accordance with this aspect, the proportional valve can be adapted and configured to adjust between 0% and 100%, at any percent flow therebetween to adjust a pressure drop across the valve. If so-embodied, the pulsating valve can have only open and closed positions, adjusting a pressure drop thereacross between a minimum and a maximum, allowing a maximum fuel flow, or completely stopping fuel flow, in each respective position. Such valves may additionally have a neutral position in which a pressure drop thereacross is intermediate and some fuel is allowed to pass by.

The delivery conduit can be adapted and configured to deliver fuel to a single fuel injector. Alternatively, the delivery conduit can be adapted and configured to deliver fuel to a fuel supply manifold, which delivers fuel to a plurality of fuel injectors.

If desired, the proportional valve portion and pulsating valve portions can be formed within or held within a common housing. Additionally, the delivery conduit and/or the supply conduit, or one or more portions thereof, can be held within the housing.

Valve systems in accordance with the invention can be embodied so that the proportional valve portion modulates fuel supply to a plurality of fuel injectors and the pulsating valve portion modulates fuel supply to a single fuel injector, and is preferably arranged in close proximity thereto. This may be particularly advantageous for reducing damping within the fuel system.

In accordance with another aspect of the invention, a method for controlling the fuel pressure to a fuel nozzle to actively control combustion in a gas turbine engine, is provided. The method includes providing a valve system in accordance with the invention, receiving fuel at an initial pressure, adjusting the pressure of the fuel in response to a detected combustion condition, and delivering the fuel to a fuel injector at the adjusted pressure. The method optionally includes the step of detecting a combustion condition within the combustion chamber of the engine.

In accordance with still another aspect of the invention, a method for adjusting a supply of fuel to a fuel nozzle to actively control combustion instabilities in a gas turbine engine is provided. The method includes the steps of providing a valve system in accordance with the invention, receiving fuel at an initial pressure, adjusting the initial pressure of the fuel in proportion to an amplitude of a detected combustion instability, and delivering the fuel to a fuel injector at the adjusted pressure.

The method can further include the step of detecting combustion instability within the combustion chamber of a gas turbine engine. Further, the method can include the step of commanding the valve system to open or close to adjust a pressure drop across a valve, in proportion to the amplitude of detected combustion instability.

The step of adjusting the initial pressure of the fuel can involve pulsing fuel at a rate of about 50 to 1500 Hz, and preferably about 1000 Hz.

The step of adjusting the initial pressure can involve adjusting a valve to yield a pressure within a range between a minimum fuel pressure and a maximum fuel pressure about an average fuel pressure.

In accordance with the invention, if combustion instability is detected, the step of adjusting the initial fuel pressure can include commanding the proportional valve portion to move toward a closed position, increasing the pressure drop thereacross, thus reducing the flow of fuel passing therethrough, and allowing a higher percentage of fuel flow to be delivered through the pulsating valve portion. The proportional valve can be adapted and configured to continue to close if instability continues to be detected and wherein the proportional valve ceases to close if instability ceases to be detected. A mean combined fuel flow rate flowing through the proportional and pulsating valve portions can be kept substantially constant, if so-desired, by adjusting respective valve portions. This can be accomplished by monitoring fuel flow rate and/or pressures and adjusting valve portions accordingly.

In accordance with the invention, if combustion instability is not detected, the step of adjusting fuel pressure can include the step of commanding the proportional valve portion to move toward an open position, decreasing pressure drop thereacross and increasing the flow of fuel passing therethrough, and reducing the proportion of fuel flowing through the pulsating valve portion. If instability is not detected, the method can further include the step of commanding the pulsating valve portion to revert to a default position. The default position can be one that allows a predetermined pressure drop thereacross and a corresponding flow rate to pass therethrough, or alternatively, which is a closed position. A mean combined fuel flow rate flowing through the proportional and pulsating valve portions can be kept substantially constant, if so-desired, as set forth above.

These and other aspects of the proportional fuel pressure amplitude control valves and related methods of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the present invention pertains will more readily understand how to employ the active combustion control system of the present invention, embodiments thereof will be described in detail hereinbelow with reference to the drawings, wherein:

FIG. 1 is a side elevational cutaway view of a portion of a gas turbine engine that includes instrumented fuel injectors, for use with the devices and systems of the present invention;

FIG. 2 is a cross-sectional view taken along line 2-2 of FIG. 1, through the combustion chamber of the gas turbine engine of FIG. 1, illustrating a plurality of instrumented fuel injectors;

FIG. 3 is also a cross-sectional view taken along line 2-2 of FIG. 1, through the combustion chamber of the gas turbine engine, illustrating an alternative arrangement of fuel injectors, wherein several of the injectors are instrumented and other injectors are uninstrumented;

FIG. 4 is a schematic illustration of a valve arrangement in accordance with the invention, in which a single proportional valve portion and a single pulsating valve portion are arranged in parallel;

FIG. 5 is a schematic illustration of a valve arrangement in accordance with the invention in which a single proportional valve portion is arranged in parallel with multiple pulsating valve portions, each of which feeds fuel only to a respective fuel injector;

FIG. 6 is a schematic illustration of a valve arrangement in accordance with the invention, in which a single proportional valve portion and a single pulsating valve portion are arranged in parallel as in FIG. 4, wherein each fuel injector is provided with respective proportional and pulsating valves;

FIG. 7 is a schematic illustration of a valve arrangement in accordance with the invention, in which a single proportional valve portion and a single pulsating valve portion are arranged in parallel as in FIG. 4, wherein a plurality of fuel injectors are provided with fuel from a single pulsating valve portion and a single proportional valve portion;

FIG. 8 is a schematic illustration of a system in accordance with the invention, illustrating a valve arrangement in which a proportional valve portion and a pulsating valve portion are arranged in parallel; and

FIG. 9 is a flow chart of an example method in accordance with the invention, wherein the valves are operated in order to control engine performance.

### DETAILED DESCRIPTION

The proportional fuel pressure amplitude control valves and related methods and systems are particularly useful in conjunction with active combustion control systems, such as those described in U.S. Patent Publication Number 2007/0119147 to Cornwell et al., for example, which application is hereby incorporated by reference in its entirety. Preferably, such active combustion control systems are designed to reduce localized thermo-acoustic combustion instabilities within the combustion chamber of a gas turbine engine. In such instances, the valve assemblies disclosed herein can be employed to pulsate or otherwise modulate fuel flow to individual fuel injectors at extremely high frequencies in excess of about 1000 Hz in proportion to detected combustion instability, while additionally providing a capability for adjustable amplitude of fuel pressure of such fuel pulsations. The pulsating portion of valves in accordance with the present invention can be any suitable pulsating valve, but in accordance with a preferred aspect of the invention, are based on the pulsating valve assemblies set forth in US2007/0151252 to Cornwell et al., the disclosure of which is hereby incorporated by reference in its entirety.

The devices, systems and methods of the present invention are also intended to lower engine emissions, improve engine dynamics and maximize operating efficiency. In such instances, the valve assemblies of the subject invention can be employed to trim or otherwise actively adjust fuel flow to individual injectors to control stability as well as the temperature pattern factor in a combustor, thereby reducing hot spots and other detected undesirable combustion conditions. The subject valve assemblies and systems set forth herein can also be employed to self-tune an engine by actively adjusting localized fuel flow patterns over time, to maintain engine health.

It is envisioned that the valve assemblies disclosed herein can be used in conjunction with various types of fuel injectors, including for example, a two-stage fuel injector having main and pilot fuel flows. In such instances, the pilot fuel flow can be modulated or otherwise pulsed at high frequency relative to the main fuel flow to control combustion conditions.

Those skilled in the art will readily appreciate that the valve assemblies disclosed herein can be readily used in combustion applications outside the field of gas turbine technology. Accordingly, Applicants conceive that the systems, methods, and valve assemblies of the subject invention can be readily employed to modulate or otherwise pulse fuel flow at relatively high frequency in systems or processes outside the field of combustion technology. For example, valve assemblies as disclosed herein could find utility in applications within the chemical processing industry, such as, in fluid titration systems wherein a first process fluid is proportionally metered into a second process fluid in conjunction an active process control system. Other applications outside the field of combustion technology may include servo-valves for hydraulic systems or gaseous flow control valves in refrigeration systems.

Gas turbine engines typically have sensors for measuring operating conditions, including, for example, turbine inlet temperature, compressor speed and pressure, total fuel flow rate to the combustor, and exhaust gas temperature and pressure, thermo-chemical characteristics of the combustor flame, oscillating pressure changes that are indicative of combustion instability, and, in some instances, fuel flow rate at one or more fuel injectors delivering fuel to the combustion chamber of the engine. Such engines also have control systems to utilize the data from such sensors, as well as actuators, which are actuated by the control systems to modify engine operating parameters. Among others, such actuators can include fuel control valves.

The devices, methods and systems of the present invention are particularly suited for use in reducing thermo-acoustic combustion instabilities within the combustion chamber of gas turbine engines. The methods are particularly well suited for use in combustion including those in industrial gas turbine engines, civil aircraft, military aircraft and the like.

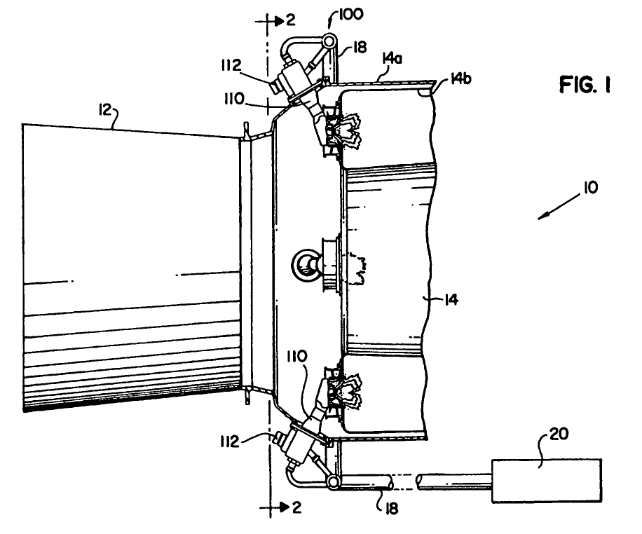

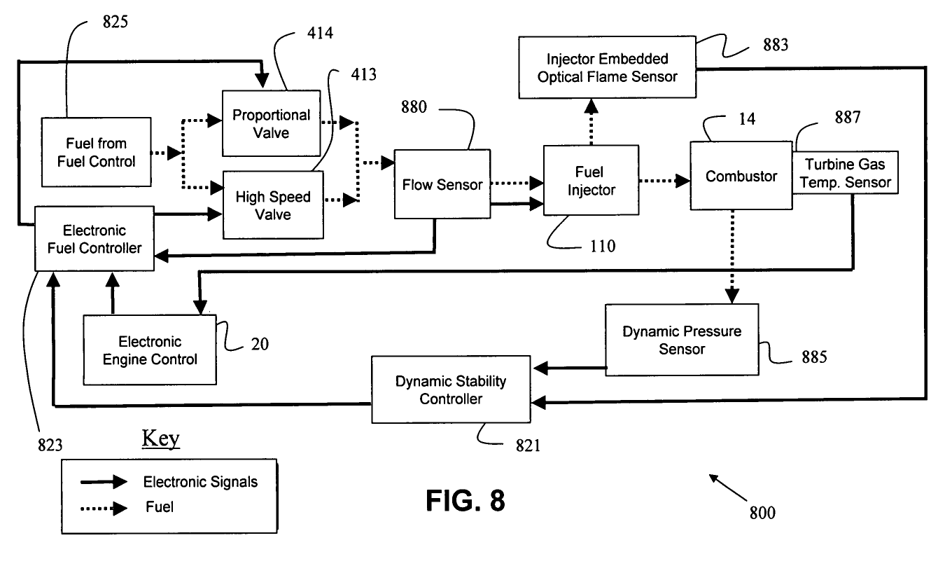

Referring now to the drawings, wherein like reference numerals identify similar features or aspects of the subject invention, there is illustrated in FIG. 1 a gas turbine engine 10 that can include, among other things, an active combustion control system or the like, which can be adapted to control valve assemblies and to implement methods of the present invention. The system is designated generally by reference numeral 100. FIG. 8 is a schematic illustration of control aspects of the system 100 in accordance with the invention, as will be discussed in more detail herein below.

In general, gas turbine engine 10 includes a compressor 12, a combustion chamber 14 downstream from the compressor 12, and a turbine (not shown) downstream from the combustion chamber 14. The combustion chamber 14 includes a generally cylindrical outer combustion liner or casing 14a and a generally annular inner combustion liner 14b. Those skilled in the art will readily appreciate that other combustor configurations are possible, such as, for example, a can-type combustor.

The combustion control system 100 includes a plurality of fuel injectors 110, each mounted to the outer casing 14a of engine 10 for issuing atomized fuel into the inner combustion liner 14b of combustion chamber 14, as depicted. As explained in more detail below, one or more of the fuel injectors 110 of system 100 is preferably instrumented in such a manner so as to facilitate measurement of thermo-chemical characteristics of the flame within combustion chamber 14, oscillating pressure changes within combustion chamber 14, and the fuel flow rate through the injector itself. In addition, as explained in more detail below, a fuel modulation valve 112 is operatively associated each instrumented fuel injector 110 to control the flow of fuel delivered thereto during engine operation.

As shown in FIG. 1, fuel is delivered to the individual fuel injectors 110, and more precisely to the respective modulation valves 112 associated therewith, by way of a distribution manifold 18. In accordance with one aspect of the subject invention, the distribution manifold 18 receives metered amounts of fuel by way of an electronic engine control 20, which can be a full authority digital electronic control (FADEC) unit. The electronic engine control 20 accepts inputs (e.g., engine operating temperatures and pressures, shaft speeds and torques, environmental conditions) from various sensors on or within the turbine engine 10, and commands the position of a primary fuel-metering valve (not shown) based on software control laws developed for the specific engine application. The software control laws are written to optimize power output and drive the gas turbine engine in a safe operating region for a given power command and set of operating conditions. The electronic engine control 20 can cooperate with combustion control system 100, as well as other controls systems that may be provided in connection with the engine 10.

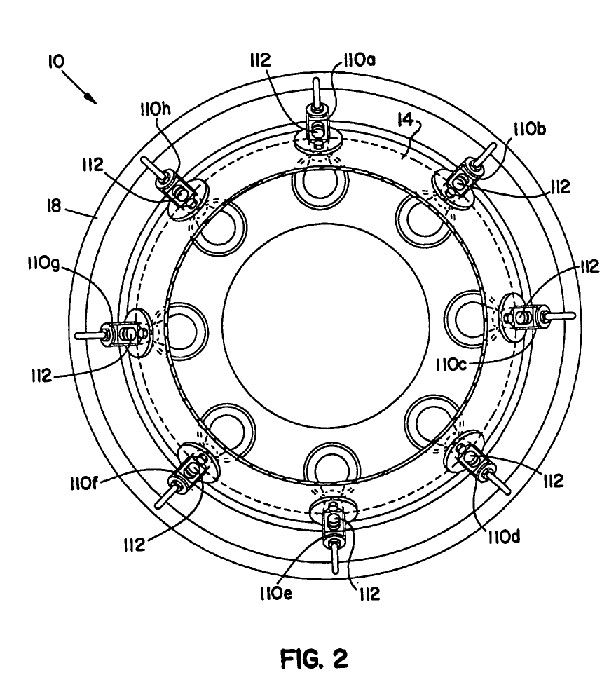

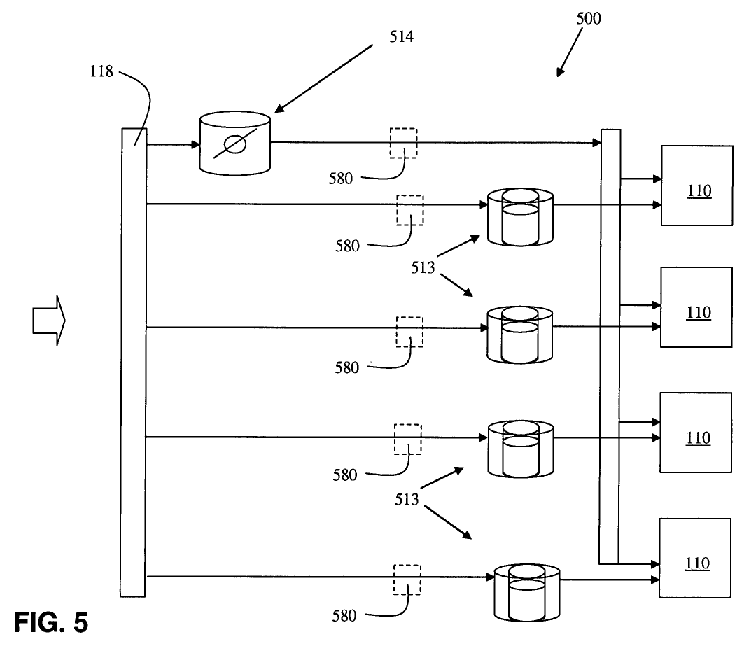

With reference to FIG. 2, there is illustrated a plurality of instrumented fuel injectors 110a-110h, which are arranged circumferentially about the periphery of the combustion chamber 14. In this arrangement, combustion characteristics including thermo-chemical flame characteristics and acoustic pressure changes can be monitored and measured in a highly localized manner throughout the entire periphery of the combustion chamber 14, by the sensing instrumentation associated with each injector 110a-110h. Thus, in instances in which the combustion characteristics in a certain location within the combustion chamber 14 are detected or otherwise measured relative to certain baseline values, the fuel pressure, and thus flow rate, to one or more of the injectors corresponding to that location in the combustor can be adjusted by the valve 112 associated therewith, so as to stabilize combustion or otherwise tune the engine. In the illustrated embodiment, and optionally with any embodiment in accordance with the invention, valves or valve elements are integrated into the body of the fuel injectors 110a-110h. Alternatively or additionally, valves or valve elements can be arranged near the fuel injectors but not integrated therewith, and certain valve portions can be integrated into the fuel injector or arranged near the fuel injectors, while other valve portions can be arranged more distant from the fuel injectors, as will become apparent, particularly in connection with the discussion of the embodiments of FIGS. 5-7, below.

Those skilled in the art should appreciate that the number of injectors shown in FIG. 2 is for illustrative purposes only and should not be deemed to limit the subject disclosure in any manner. Furthermore, it is envisioned that more than one instrumented fuel injector can be associated with a single fuel modulation valve or valve portion thereof, such as a proportional valve portion or pulsating valve portion, as will be appreciated from the discussion of the embodiments of FIGS. 5-7, below. Thus, while each injector 110a-110h shown in FIG. 2 includes a respective fuel modulation valve 112, it is envisioned that a particular fuel modulation valve 112 can be configured to modulate fuel to plural fuel injectors, for example, to each injector within a particular quadrant or zone of the combustion chamber 14. Accordingly, a manifold, such as manifold 18, may be used to distribute fuel from a valve 112 to multiple fuel injectors.

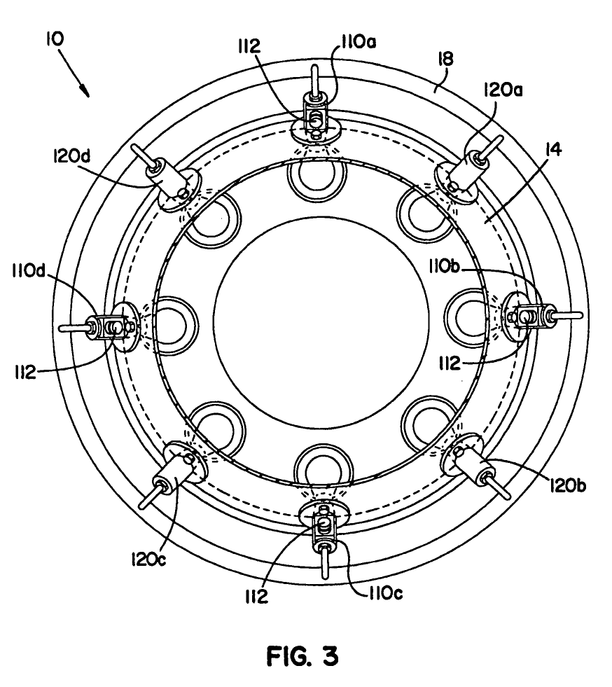

In an example alternative injector arrangement illustrated for example in FIG. 3, some of the fuel injectors provided in the engine 10 are instrumented and separately modulated with integral valves 112, while some injectors are not instrumented or separately modulated with integral valves. In particular, injectors 110a, 110b, 110c and 110d are instrumented so as to operate in accordance with the principles of the subject invention and include respective fuel modulation valves 112. In contrast, fuel injectors 120a, 120b, 120c and 120d are not instrumented, but instead they are configured in a more conventional manner to deliver atomized fuel to the combustion chamber 14 by the instrumented injectors. In such an arrangement, combustion characteristics are monitored and measured within certain combustion zones or quadrants of the combustion chamber 14. It is envisioned that such an arrangement may be sufficient to actively control combustion in many engine applications. In such a configuration, combustion characteristics within a certain combustion zone or quadrant can be actively controlled by modulating fuel flow to one or more of the instrumented injectors 110a-110d associated with that zone or quadrant. This can be accomplished with each instrumented injector 110a-110d having a respective modulation valve 112 or valve portion as shown, or in the alternative, a modulation valve or valve portion can be associated with more than one instrumented injector.

Those skilled in the art will readily appreciate that the circumferential position of the instrumented fuel injectors 110 and/or the number of instrumented fuel injectors 110 can vary depending upon the engine configuration and application. Indeed, it is envisioned and well within the scope of the subject disclosure that certain engine applications may only require a single instrumented injector 110, while the remainder of the fuel injectors in the engine are configured to operate in a more conventional manner.

Each instrumented fuel injector 110 of the active combustion control system 100, for use with the subject methods, may include a fuel mass flow sensor for monitoring fuel flow rates at each fuel injector. The fuel mass flow sensors, in accordance with one aspect, are adapted and configured to operate at line pressures of between 200 to 1500 psig, and are designed to cover a range of fuel flow from 25% to 100% and a modulation of about ±20% of the average mean fuel flow to the nozzle. The location of the fuel mass flow sensor within the fuel injector can vary, as long as it is positioned to provide a precise measurement of the fuel rate flowing through a nozzle.

As described above, at least one injector 110, and if desired, all injectors, include(s) a fuel modulation valve 112 adapted and configured to modulate fuel pressure and thus also fuel flow rate to the injectors 110 in response to combustion instability detected by sensors provided, such as dynamic pressure sensors, flame sensors or others. More particularly, fuel modulation valves 112 are configured to modulate fuel flow in proportion to detected combustion instability up to about ±20% of the mean fuel flow rate, at a frequency of up to 1000 Hz.

U.S. Patent Publication Number 2007/0151252 to Cornwell et al., which is herein incorporated by reference in its entirety, discloses three embodiments of a high speed fuel modulation valve that can be used in conjunction with the instrumented fuel injectors 110 of the combustion control system 100. Alternatively, simple binary valves having only open and closed positions and electro-mechanical proportional valves can be substituted for or used in conjunction with valves such as those described by Cornwell.

It is also envisioned and well within the scope of the subject disclosure that alternative types of valve actuators can be utilized with the active combustion control system 100 of the subject invention, to modulate or otherwise deliver proportional and/or pulsed fuel flow to the instrumented injectors 110. These include, for example, electromagnetic, magneto-strictive valve actuators, piezoelectric valve actuators, valve actuators employing cavitating piezoelectric fuel modulation, MEMS type actuators (thermal, fluid or mechanical amplifiers), electro-dynamic valve actuators, and rotary-type valve actuators.

In accordance with the subject methods and related systems, one or more valves can be utilized in the process of actively trimming and staging fuel in a gas turbine engine. Such valves, as set forth above, can be actuated by any suitable means, but preferably include electromechanical actuation. Such valves can include but are not limited to proportional valves, such as proportional valves, and pulsating valves, capable of rapid movement. As set forth above, however, any of the valves described in U.S. Patent Publication Number 2007/0151252 to Cornwell, or variations thereof, can be utilized for as the proportional valve and/or as a pulsating valve, in accordance with the invention.

In use, utilizing data obtained though the sensors described above, the electronic engine control 20 operates valve associated with each of the fuel injectors 120a-120h, adjusting the pressure drop thereacross and thus, the flow of fuel therethrough. Accordingly, if a combustion instability is indicated by the measurements taken from the sensors, fuel pressure can be adjusted to remedy such instability by actuating the respective valve. If the valve is a proportional valve that can be adjusted to result in a pressure drop yielding a particular mass flow rate range, then adjustments of any increment can be made accordingly. Moreover, the pulsating valve can be used to pulse fuel at a desired frequency to counteract combustion instability, as determined by the electronic engine control 20.

Moreover, one or more of the fuel injectors 120a-120h can be provided fuel by multiple fuel circuits. For example, fuel to each fuel injector can be provided by main and pilot fuel circuits, or by a common fuel supply circuit. The flow of fuel coming from each of these circuits and through the main and pilot fuel circuits within the injector 120 can be controlled with separate valves contained within an injector assembly. Alternatively, one or more of the valves can be arranged nearby on a conduit leading to the injector, or instead, in connection with a manifold feeding multiple injectors, as discussed hereinbelow. One valve is preferably a proportional type valve, and one or more of the valves is preferably a pulsating type valve. In accordance with one aspect, flow of pilot fuel can be controlled by way of a pulsating valve and flow of main fuel can be controlled by way of a proportional valve, for example.

The proportional fuel pressure amplitude control systems, valves and related methods are particularly useful in conjunction with active combustion control systems, such as those described in US 2007/0119147 to Cornwell et al., for example, which application is hereby incorporated by reference in its entirety. Preferably, such active combustion control systems are designed to reduce localized thermo-acoustic combustion instabilities within the combustion chamber of a gas turbine engine. In such instances, the valve assemblies disclosed herein can be employed to pulsate or otherwise modulate fuel flow to individual fuel injectors at extremely high frequencies in excess of about 1000 Hz in proportion to detected combustion instability, while providing a capability for adjustable amplitude of fuel pressure of such fuel pulsations. The pulsating portion of valves in accordance with the present invention can be any suitable pulsating valve, but in accordance with a preferred aspect of the invention, are based on the pulsating valve assemblies set forth in US2007/0151252 to Cornwell et al., the disclosure of which, as set forth above, is hereby incorporated by reference in its entirety.

The devices, systems and methods of the present invention are also intended to lower engine emissions, improve engine dynamics and maximize operating efficiency. In such instances, the valve assemblies of the subject invention can be employed to trim or otherwise actively adjust fuel flow to individual injectors to control stability as well as the temperature pattern factor in a combustor, thereby reducing hot spots and other detected undesirable combustion conditions. The subject valve assemblies and systems set forth herein can also be employed to self-tune an engine by actively adjusting localized fuel flow patterns over time, to maintain engine health.

It is envisioned that the valve assemblies disclosed herein can be used in conjunction with various types of fuel injectors, including for example, a two-stage fuel injector having main and pilot fuel flows. In such instances, the pilot fuel flow can be modulated or otherwise pulsed at high frequency relative to the main fuel flow to control combustion conditions.

Those skilled in the art will readily appreciate that the valve assemblies disclosed herein can be readily used in combustion applications outside the field of gas turbine technology.

It is envisioned that the systems, methods, and valve assemblies of the subject invention could be readily employed to modulate or otherwise pulse fluid flow at relatively high frequency in systems or processes outside the field of combustion technology. For example, valve assemblies as disclosed herein could find utility in applications within the chemical processing industry, such as, in fluid titration systems wherein a first process fluid is proportionally metered into a second process fluid in conjunction an active process control system. Other applications outside the field of combustion technology may include servo-valves for hydraulic systems or gaseous flow control valves in refrigeration systems.

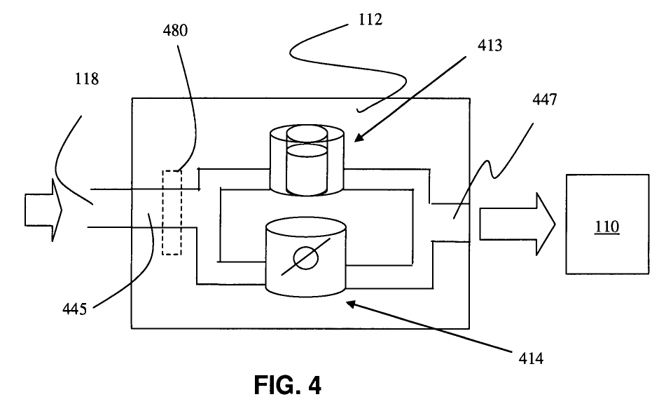

FIGS. 4-7 illustrate example embodiments of valves in accordance with the present invention in which each fuel injector 110 is fed by a pulsating valve portion, and a proportional valve portion, such as pulsating valve portion 413, and proportional valve portion 414 in FIG. 4, arranged in parallel. The valve portions can be provided in the same housing, integrated with a fuel injector or separately provided between a main fuel distribution manifold and the fuel injectors.

FIG. 4 illustrates the simplest arrangement of a valve 112 in accordance with the invention, in which each of the proportional valve portion 414 and pulsating valve portion 413 are provided in a common housing 440, arranged in parallel with respect to fuel flow. Fuel is provided from a distribution manifold 118 to the valve 112, and subsequently to the fuel injector 110. An internal supply conduit 445 and delivery conduit 447 provide the internal fluid channels through which fuel flows during operation.

Fuel flow can therefore be modulated using the pulsating valve portion 413 and/or the proportional valve portion 414 to maintain desired engine operation, and to promote combustion stability. In conditions of combustion stability, the desired fuel flow is set using the proportional valve portion 414, after which the pulsating valve portion 413 can be operated if combustion instability is detected, as determined and controlled by a control system, in order to promote and maintain combustion stability. To maintain a constant flow rate of fuel, when the pulsating valve portion 413 is operated, the proportional valve portion 414 can be closed to an appropriate degree in order to provide an appropriate pressure drop to maintain the desired flow rate of fuel. Alternatively, the pulsating valve portion 413 can be used to momentarily increase or decrease the flow rate of fuel to the respective injector or injectors, without closing the proportional valve portion 414.

Similarly, if the pulsating valve portion 413 is the only valve portion delivering fuel, and additional fuel is required to maintain engine operation, the proportional valve portion 414 can be opened by the necessary amount to provide increased fuel flow through the valve 112.

When combustion stability is once again determined to be within acceptable limits, the pulsating valve portion 413 will revert to a default position which can be a closed position, open position or partially open position, as desired or required. The proportional valve portion 414 can then resume providing a uniform flow of fuel.

Accordingly, at one extreme, under normal operating conditions and without excessive combustion instability, the pulsating valve portion 413 is closed or otherwise in a static state (e.g., a partially or fully open state), and the proportional valve portion 414 is used to actively adjust the fuel pressure to the injector 110. At the other extreme, under conditions of combustion instability, the proportional valve portion 414 is commanded into the closed position, with all fuel flowing through the valve 112 flowing through the pulsating valve portion 413, being modulated at a frequency capable of promoting combustion stability. Moreover, when both the pulsating valve portion 413 and proportional valve portion 414 are operating, flow rate of fuel can be maximized and amplitude control of fuel pulses can be realized. This may be necessary, for example under conditions of combustion instability and high power demand. During operation of the pulsating valve portion 413, fuel pulsations are generated at a commanded interval by the control system. The resultant pulsations can be proportionally controlled with use of the proportional valve portion 414, that controls the relative amount of fuel flow that is unmodulated versus modulated. As a result, pulsation amplitude control of fuel flow is obtained.

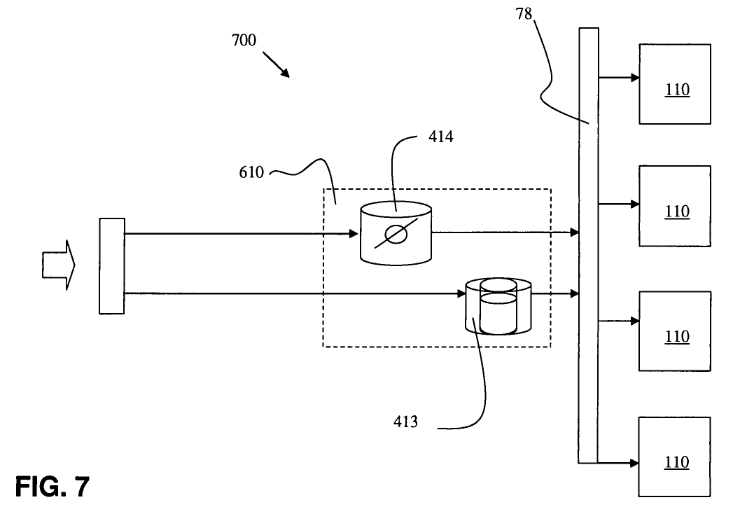

Accordingly, as illustrated in FIGS. 4-7, fuel can be delivered through each of the proportional valve portion 414 and the pulsating valve portion 413 separately all the way to a nozzle of the fuel injector and directly injected into the combustor. Alternatively, the fuel passing through each respective valve portion can be rejoined within the valve, as in the embodiment of FIG. 4, into an intermediate manifold feeding one injector, or into an intermediate manifold feeding multiple injectors, as in the embodiment of FIG. 7. It also may prove desirable for the purposes of weight and space savings to provide a single proportional valve portion providing fuel to multiple fuel injectors via an intermediate manifold, in combination with distributed pulsating fuel control at each individual injector, as described in more detail below in connection with the embodiment of FIG. 5.

As set forth above, in transitional periods when switching from purely proportional modulation to purely pulsating modulation, both valves are in a transitional state, wherein a constant flow rate of fuel can be maintained by comparing measurements obtained from flow rate sensors, for example. Such flow rate sensors can be provided to measure the flow rate of fuel passing through the entire valve 112, by placing a flow rate meter in either the supply conduit 445 leading to or the delivery conduit 447 leading from the valve 112, such as in the position of the optional flow rate meter 480 illustrated in dashed lines in FIG. 4. Alternatively, more precise measurement of amounts of fuel being contributed by each valve portion can be obtained by placing a flow rate meter in a conduit leading to or from only one of the valve portions, as illustrated, for example, by the placement of optional flow rate meters 580 in the embodiment of FIG. 5.

FIG. 5 illustrates an alternate embodiment for a valve system 500 in accordance with the present invention, in which a single proportional valve 514 provides fuel to a common manifold 58, is arranged in parallel with multiple pulsating valves 513, each of which provides fuel to a single fuel injector. In the illustrated embodiment, fuel originates from a common fuel distribution manifold 118 and is distributed to the multiple pulsating valves 513 and the single proportional valve 514. Naturally, if necessary, more than one proportional valve can be provided to decrease the pressure drop thereacross and thus increase fuel flow to the manifold 58.

As mentioned above, fuel delivered to the injectors 110 from each respective pulsating valve 513, and from the proportional valve 514 via the manifold 58 can remain separate in separate fuel circuits through the fuel injector 110 into the nozzles in the combustor. Alternatively, the fuel flow can be combined prior to or within the injector 110 to be distributed through a single fuel circuit (e.g., the main fuel circuit) of the injector 110. Accordingly, if desired, any of the illustrated arrangements for fuel delivery in FIGS. 2-7 can be used in parallel with a more conventional fuel delivery system, such as one delivering only pilot fuel to the pilot fuel circuit of the fuel injectors 100, for example.

In the valve system 500 of FIG. 5, placement of the pulsating valves 513 is preferably close to the injector 110, if not integrated therewith, as illustrated in FIGS. 1-3, in order to minimize the effects of internal damping by the fuel system of the high-frequency fuel pulsations. Due to the relatively slow rate of fuel modulation by the proportional valve 514, placement of the valve is less critical, and the extra volume defined by the intermediate distribution manifold 58 is not detrimental to the efficacy of the system 500 as a whole.

Operation of the system 500 is similar to that of the embodiment of FIG. 4. However, as is apparent, in the embodiment of valve system 500, any fuel passing through the proportional valve portion 514 is distributed equally to each of the fuel injectors 110. During operation, particularly while transitioning between proportional and pulsed fuel modulation, optional flow rate meters 580, in combination with the control system, can compare fuel flow rates to assure that an appropriate net amount of fuel is being delivered to the injectors 110, and that the valves are opening or closing appropriately to maintain the desired fuel flow rate. Alternatively, in lieu of direct fuel flow rate measurements, the control system can be adapted and configured to calculate fuel flow rates based on fuel pressure and/or and valve position sensors, which can alternatively or additionally be provided on the proportional valve 514 and/or the pulsating valve 513.

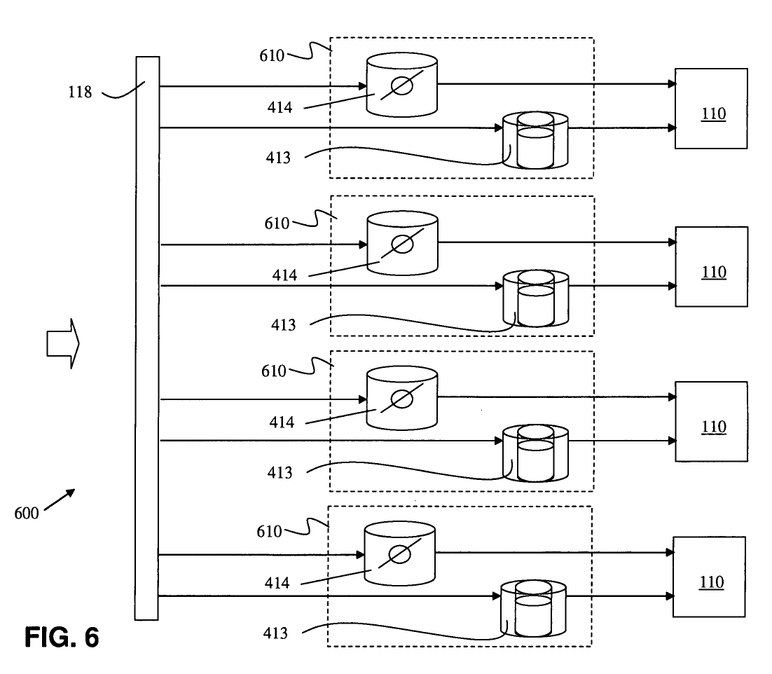

In the embodiment of FIG. 6, which is a schematic illustration of a valve system 600 in accordance with the invention, each fuel injector 110 is provided fuel by a proportional valve portion 414 and a pulsating valve portion 413. The proportional valve portion 414 and pulsating valve portion 413 can be provided in a common housing 610, as illustrated in dashed line, alternatively can be integrated with the body of each respective fuel injector 110, or can be provided separately, but still in a parallel arrangement. Accordingly, if desired, one valve portion can be provided within the body of the fuel injector, such as the pulsating valve portion 413, with the other valve portion being provided separately. In any case, it is preferable to arrange the pulsating valve portion 413 relatively near the fuel injector 110, to minimize fuel system damping.

Naturally, with regard to fuel flow, the fuel delivered from each of the proportional valve portion 414 and pulsating valve portion 413 can be combined in an intermediate manifold prior to or within the fuel injector 110, or can remain as separate flows through the injector 110, and to the nozzles.

FIG. 7 illustrates a simplified valve arrangement 700 for use in turbine engines, which includes proportional 414 and pulsating 413 valve portions that feed an intermediate distribution manifold 78, which in-turn feeds fuel to a plurality of fuel injectors 110. Due to the relative simplicity of the valve arrangement 700, it may be particularly suitable for small engines and/or in engines where excess space is at a minimum. As illustrated, the proportional 414 and pulsating 413 valve portions can be provided in a common housing 610, as with other embodiments. Alternatively, the valve portions can be provided separately, which may be desirable due to space constraints in and around the turbine engine. As mentioned above, it is preferred that the pulsating valve portion 413 be arranged as close to the fuel injectors 110 as possible. Accordingly, due to the presence of the distribution manifold 78, placement of the pulsating valve portion 413 relatively close to the manifold 78 is preferred. If so-desired, a second set of proportional 414 and pulsating 413 valve portions can be provided in parallel feeding the same manifold 78, for the purpose of redundancy, to provide increased fuel flow to the injectors 110, or for providing increased rate or amplitude of fuel pulsation with two out-of-sync or synchronized pulsating valves, respectively.

FIG. 8 is a schematic illustration of a system 800 in accordance with the invention, illustrating a valve arrangement in which a proportional valve portion 414 and a pulsating valve portion 413 are arranged in parallel. In FIG. 8, electronic signals between system elements are represented by a solid arrow, while fuel flow is represented by dashed arrows. As illustrated, fuel is supplied by way of a fuel control 825, which need not deviate from typical fuel controls of the art, to the proportional valve portion 414 and a pulsating valve portion 413. As illustrated, a flow rate sensor 880 is provided to measure flow rate exiting a single conduit leading from the valves. As mentioned above, however, alternate arrangements for measuring flow rate and/or alternate placement of flow sensors are conceived.

Fuel passes from the valves 413 and 414 to the fuel injector 110, and into the combustor 14. Various sensors then communicate with one or more control units. More specifically, a temperature reading is fed back from a turbine temperature sensor 887 to an electronic engine control 20. A dynamic combustion stability controller 821 receives information from various sensors, such as an optical flame sensor 883 and a dynamic pressure sensor 885 to facilitate detection of combustion instability. Naturally, multiple sensors of each type can be provided to determine operating conditions more precisely throughout the engine and/or to provide redundancy.

The electronic engine control 20 manages operation of the engine in concert with other controls, including the stability control 821 and fuel control 823, for example. The electronic fuel controller 823 is adapted and configured to receive information from the stability control 821, and from the electronic engine control 20. The electronic fuel controller 823 is also adapted and configured to operate the proportional valve 414 and pulsating valve 413 in accordance with a program, in response to stability and power demand information, to provide the appropriate amount of power output and to promote combustion stability. Naturally, other control systems or control features can be incorporated into the system 800, such as an active pattern factor control system, for example. In active pattern factor control, the system can be augmented by including sensors that measure the temperature at the exit of the combustor and utilize this information to trim the fuel flow up or down at the fuel injectors that are associated with affecting the temperature at the desired location, for example.

In accordance with one aspect of the invention, a method for controlling the flow of fuel to a fuel nozzle to actively control combustion in a gas turbine engine is provided, which includes providing a valve system in accordance with the invention, as set forth above, receiving fuel at an initial pressure with corresponding flow rate, adjusting the pressure of the fuel in response to a detected combustion condition, and delivering the fuel to a fuel injector at the adjusted pressure. The method optionally includes the step of detecting a combustion condition within the combustion chamber of the engine.

In accordance with still another aspect of the invention, a method for adjusting a supply of fuel to a fuel nozzle to actively control combustion instabilities in a gas turbine engine is provided. The method includes the steps of providing a valve system in accordance with the invention, receiving fuel at an initial pressure, adjusting the initial pressure of the fuel in proportion to an amplitude of a detected combustion instability, and delivering the fuel to a fuel injector at the adjusted pressure.

The method can further include the step of detecting combustion instability within the combustion chamber of a gas turbine engine. Further, the method can include the step of commanding the valve system to adjust the fuel flow rate in proportion to the amplitude of detected combustion instability.

The step of adjusting the initial fuel pressure can involve pulsing fuel at a rate of about 50 to 1500 Hz, and preferably about 1000 Hz.

The step of adjusting the initial fuel pressure can involve adjusting within a range that extends between a minimum fuel flow rate and a maximum fuel flow rate about an average fuel flow rate.

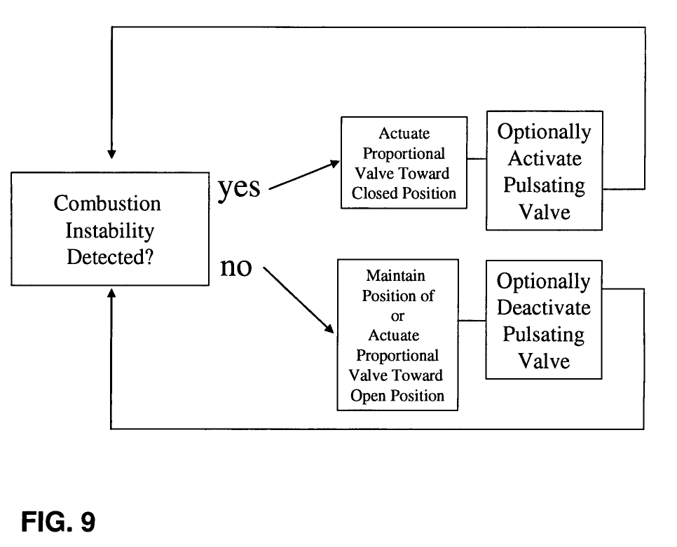

FIG. 9 is a flow chart of an example method in accordance with the invention, wherein the valves are operated in order to control engine operation. In accordance with the invention, if combustion instability is detected, the step of adjusting fuel pressure and thus flow rate, can include activating the pulsating valve and/or commanding the proportional valve portion to move toward a closed position, increasing a pressure drop across the valve and proportionately reducing the flow of fuel passing therethrough, and allowing a higher percentage of fuel flow to be delivered through the pulsating valve portion. The proportional valve can be adapted and configured to continue to close if instability continues to be detected, allowing increasing amounts of fuel to be pulsed. Further, the proportional valve can cease to close if instability is no longer detected.

In accordance with the invention, if combustion instability is not detected, the step of adjusting fuel flow rate can include the step of commanding the proportional valve portion to move toward an open position, decreasing a pressure drop thereacross and thus increasing the flow of fuel passing therethrough, thereby reducing the proportion of fuel flowing through the pulsating valve portion. If instability is not detected, the method can further include the step of commanding the pulsating valve portion to revert to a default position. The default position can be one that results in a predetermined pressure drop across the valve and thus allows a predetermined flow rate of fuel to pass therethrough, or alternatively, which is a closed position.

In applications in which above-described valves and valve systems are employed to control the thermal pattern factor within a combustion chamber of a gas turbine engine, typically, such conditions would include adjustment of the proportional valve or valves, while the pulsating valve or valves remain in a static state (i.e. not pulsating). The fuel flow rate can be actively adjusted or otherwise trimmed up or down relative to a steady-state or average pressure or fuel flow rate condition, to reduce or otherwise moderate a detected hot spot or the like. In such instances, the pressure drop across the valve could be stepped up or down from a first steady-state condition corresponding, for example, to the valve assembly being in a neutral position to another steady-state condition in which the pressure drop is increased or decreased relative to the pressure drop exhibited by having the valve assembly in a neutral position.

For example, when controlling pattern factor with the systems in accordance with the invention, an electronic engine control 20 (e.g., FADEC) commands the valve assemblies associated with certain fuel injectors (e.g., injectors 110b, 110d, 110f and 110g) to close, resulting in an increased pressure drop thereacross, thereby delivering a smaller percentage of fuel to the combustion chamber than the valve assemblies associated with other fuel injectors (e.g. injectors 110a, 110c, 110e and 110h) to thereby adjust the pattern factor in the combustor. In this case, a proportional valve portion (e.g. proportional valve 414) is preferably used in order to trim the fuel by the desired amount.

Further, it is possible to accomplish fuel staging in turbine engines, utilizing valves in accordance with the invention. Particularly, embodiments such as those in FIGS. 5 and 6, where each injector is provided a set of independent valves, or the embodiment of FIG. 7, if two or more such arrangements are provided, one set of valves can remained closed and their associated fuel injectors 110 can be shut down while another valve set and associated fuel injectors can remain active.

With reference to FIG. 8, for the purpose of illustration, in accordance with the invention, in an active fuel trimming mode the proportional valve portion 414 of the valve assembly is preferably used to proportionately adjust a pressure drop thereacross and thus deliver a proportion of the mean fuel flow through one or more of the instrumented fuel injectors 110 (e.g. injectors 110a-110h) as commanded by the electronic engine control system 20. In an active staging mode, each of the valve portions associated with each of the instrumented fuel injectors 110 is either completely closed to fuel flow or open to fuel flow, as commanded by electronic engine control 20. In the case of two stage fuel injectors having both main and pilot fuel circuits, the main and/or pilot fuel circuits in each fuel injector can be actively trimmed and/or staged in this manner. The valves used to accomplish this can be any of those set forth above.

Although the systems and related devices and methods of proportional fuel pressure amplitude control of the subject invention have been described with respect to preferred embodiments, those skilled in the art will readily appreciate that changes and modifications may be made thereto without departing from the spirit and scope of the subject invention. Particularly, it is to be understood that specific aspects of the invention described in connection with one embodiment can additionally be applied to any other embodiment set forth herein.

We claim:

1. A valve system for controlling a flow of fuel in a gas turbine engine, the valve system comprising:
a) a supply conduit adapted and configured for receiving and carrying a flow of fuel;
b) a proportional valve portion in fluid connection with the supply conduit adapted and configured to gradually adjust a pressure drop thereacross; and
c) a pulsating valve portion in fluid connection with the supply conduit, in parallel with the proportional valve portion, the pulsating valve portion being adapted and configured to rapidly adjust a pressure drop thereacross.

2. The valve system of claim 1, further comprising a delivery conduit in fluid communication with an outlet of the proportional and pulsating valve portions, adapted and configured for conducting a flow of fuel therefrom to at least one fuel circuit of a fuel injector.

3. The valve system of claim 1, further comprising a delivery conduit in fluid communication with an outlet of the proportional and pulsating valve portions, adapted and configured for conducting a flow of fuel therefrom to a manifold for distributing a flow of fuel to a plurality of fuel injectors.

4. The valve system of claim 1, wherein the proportional valve portion is in fluid communication with a manifold to adjust a pressure of fuel provided to a plurality of fuel injectors, and a plurality of pulsating valve portions are provided and are configured and adapted to each adjust fuel pressure provided to a respective fuel injector.

5. The valve system of claim 4, wherein:
a) a flow of fuel from the proportional valve portion is fed through the manifold to a first fuel circuit of a fuel injector; and
b) a flow of fuel from one of the pulsating valve portions is fed to a second fuel circuit of the fuel injector.

6. The valve system of claim 4, wherein:
a) a flow of fuel from the proportional valve portion is fed through the manifold to a first fuel circuit of a fuel injector; and
b) a flow of fuel from one of the pulsating valve portions is also fed to the first fuel circuit of the fuel injector.

7. The valve system of claim 1, wherein the proportional valve is adapted and configured to adjust between 0% and 100% of allowable pressure drop, at any percent of allowable pressure therebetween.

8. The valve system of claim 1, wherein the pulsating valve has only open and closed positions, allowing a maximum fuel flow, or completely stopping fuel flow, in each respective position.

9. The valve system of claim 1, wherein the delivery conduit is adapted and configured to deliver fuel to a single fuel injector.

10. The valve system of claim 1, wherein the delivery conduit is adapted and configured to deliver fuel to a fuel supply manifold, which delivers fuel to a plurality of fuel injectors.

11. The valve system of claim 1, wherein the proportional valve portion and pulsating valve portions are held within a common housing.

12. The valve system of claim 6, wherein the delivery conduit and the supply conduit are held within the housing.

13. The valve system of claim 1, wherein the proportional valve modulates fuel supply to a plurality of fuel injectors and the pulsating valve modulates fuel supply to a single fuel injector.

14. A method for controlling the flow of fuel to a fuel nozzle to actively control combustion in a gas turbine engine, the method comprising the steps of:
a) providing a valve system comprising:
i) a supply conduit adapted and configured for receiving and carrying a flow of fuel;
ii) a proportional valve portion in fluid connection with the supply conduit adapted and configured to gradually adjust a pressure drop thereacross; and
iii) a pulsating valve portion in fluid connection with the supply conduit, in parallel with the proportional valve portion, the pulsating valve portion being adapted and configured to rapidly adjust a pressure drop thereacross;
b) receiving fuel at an initial pressure;
c) adjusting the pressure of the fuel in response to a detected combustion condition; and
d) delivering the fuel to a fuel injector at the adjusted pressure.

15. The method according to claim 14, further comprising the step of detecting a combustion condition within the combustion chamber of the engine.

16. A method for adjusting a supply of fuel to a fuel nozzle to actively control combustion instabilities in a gas turbine engine, the method comprising the steps of:
a) providing a valve system comprising:
i) a supply conduit adapted and configured for receiving and carrying a flow of fuel;
ii) a proportional valve portion in fluid connection with the supply conduit adapted and configured to gradually adjust a pressure drop thereacross; and
iii) a pulsating valve portion in fluid connection with the supply conduit, in parallel with the proportional valve portion, the pulsating valve portion being adapted and configured to rapidly adjust a pressure drop thereacross;
b) receiving fuel at an initial pressure;
c) adjusting the initial pressure of the fuel in response to detected combustion instability; and
d) delivering the fuel to a fuel injector at the adjusted pressure.

17. The method according to claim 16, further comprising the step of detecting combustion instability within the combustion chamber of a gas turbine engine.

18. The method according to claim 17, further comprising the step of commanding the valve system to adjust the fuel pressure in proportion to the amplitude of detected combustion instability.

19. The method according to claim 16, wherein the step of adjusting the initial pressure of the fuel involves pulsing fuel at a rate between about 50 to 1500 Hz.

20. The method according to claim 16, wherein the step of adjusting the initial pressure involves adjusting within a range that extends between a minimum pressure and a maximum pressure about an average pressure.

21. The method of claim 16, wherein, if combustion instability is detected, the step of adjusting fuel flow rate includes commanding the proportional valve portion to move toward a closed position, increasing a pressure drop thereacross and thus reducing the flow of fuel passing therethrough, thereby allowing a higher percentage of fuel flow to be modulated by the pulsating valve portion.

22. The method of claim 21, wherein a mean combined fuel flow rate flowing through the proportional and pulsating valve portions is substantially constant.

23. The method of claim 21, wherein the proportional valve continues to close if instability continues to be detected and wherein the proportional valve ceases to close if instability ceases to be detected.

24. The method of claim 16, wherein if combustion instability is not detected, the step of adjusting fuel flow rate includes the step of commanding the proportional valve portion to move toward an open position, decreasing a pressure drop thereacross and thus increasing the flow of fuel passing therethrough, and reducing the proportion of fuel flowing through the pulsating valve portion.

25. The method of claim 24, wherein a mean combined fuel flow rate flowing through the proportional and pulsating valve portions is substantially constant.

26. The method of claim 24, if instability is not detected, the method further comprising the step of commanding the pulsating valve portion to revert to a default position.

27. The method of claim 26, wherein the default position provides for a predetermined pressure drop thereacross, yielding a corresponding predetermined flow rate of fuel passing therethrough.

28. The method of claim 26, wherein the default position is a closed position.
